(19) United States
(12) Patent Application Publication
(10) Pub. No.: US 2011/0110117 A1
(43) Pub. Date: May 12, 2011

(54) Optical member and backlight using the same

(76) Inventors: Masashi Takai, Saitama (JP); Sachiko Ando, Aichi (JP); Yohei Funabashi, Tokyo (JP); Yasumaro Toshima, Saitama (JP); Takashi Shimizu, Saitama (JP); Masayuki Nakatani, Saitama (JP); Reiko Takahashi, Saitama (JP); Hiroshi Matsuyama, Saitama (JP)

(21) Appl. No.: 10/590,872

(22) PCT Filed: Feb. 24, 2005
(86) PCT No.: PCT/JP05/03018

§ 371 Date: Aug. 25, 2006

(30) Foreign Application Priority Data
Feb. 27, 2004 (JP) 2004-052780
Feb. 27, 2004 (JP) 2004-052781
Mar. 25, 2004 (JP) 2004-088625
Mar. 29, 2004 (JP) 2004-094651
Mar. 29, 2004 (JP) 2004-094652

(51) Int. Cl. F21V 8/00; G02B 1/10; G09F 13/04

(52) U.S. Cl. 362/629; 359/507; 362/97.1

(57) ABSTRACT

There is provided a light diffusive plate and a light guide plate, in which the generation of deflection, a cause of defective imaging, can be prevented.

On both surfaces and/or end surfaces of a light diffusive plate 1 made of synthetic resin, a moisture proof layer 2 made of a material having lower vapor permeability than that of the light diffusive plate 1 is formed to produce a light diffusive plate 3. On both surfaces and/or end surfaces of a light guide plate 1 made of synthetic resin, which has at least on end as a light incident surface and a surface almost orthogonal with it as a light emergent surface, a moisture proof layer 2 made of a material having lower vapor permeability than that of the light guide plate 1 is formed to produce a light guide plate 3.

### FIELD OF THE INVENTION

The present invention relates to a light diffusive plate, a light guide plate and other optical members used for a backlight and the like, and in particular to the optical members which do not undergo changes in dimension and deterioration of optical properties over a long time. The present invention also relates to a backlight using these optical members.

### BACKGROUND OF THE INVENTION

The quantity of backlights used for liquid crystal displays, light sign boards and the like is dramatically increasing along with the increasing shipment of liquid crystal displays for lap-top computers and large liquid crystal televisions.

As such backlight, edge-light type or direct type is mainly used. The edge-light type backlight is used for lap-top computers because the thickness of the edge-light type backlight can be reduced, while the direct type backlight is often used for large liquid crystal televisions.

Such backlights comprise light source, light guide plate and light diffusive plate, as well as prism sheet, light diffusive film, light reflecting film, polarizing film, reflective polarizing film, retardation film, electromagnetic interference (EMI) shielding film, and the like (See patent reference 1).
Patent document 1: Japanese Patent Application No. H09(1997)-127314 (claim 1, paragraph 0034)

### DISCLOSURE OF THE INVENTION

### Problems to be Solved by the Invention

In the liquid crystal displays using above-mentioned backlight, defective imaging is very unlikely to occur over time except for defective switching of the light source. Recently, however, with the increasing size of a liquid crystal display, it becomes to be reported that local imaging becomes different from that in the surrounding area on the screen a few hours after the display is switched.

Inventors of this present invention conducted diligent studies to solve the above-mentioned problem, and found that the above-mentioned defective imaging was caused by deflection and waving of a light diffusive plate and/or a light guide plate comprising a backlight and localized wrinkles on other sheet-shaped optical members. They also found that deflection, waving and wrinkles of these optical members are caused by the functions of the optical members to absorb and release moisture. Thus, the present invention was accomplished.

### Means for Solving the Problems

Specifically, the optical member of this invention is a plane optical member comprising a single or multiple layers, wherein both surfaces and/or end surfaces of at least one of the layers consisting of the optical member are provided with a moisture proof layer made of a material having lower vapor permeability than the one of the layers.

In the present invention, the optical member includes, in addition to a light diffusive plate and a light guide plate, an optical film or optical sheet used mainly for a backlight, such as prism sheet, light diffusive film, light reflecting film, polarizing film, reflective polarizing film, retardation film, electromagnetic interference (EMI) shielding film, and the like.

The optical member of the present invention is a light diffusive plate comprising synthetic resin, wherein both surfaces and/or end surfaces of the afore-mentioned light diffusive plate are provided with a moisture proof layer comprising a material having lower vapor permeability than that of the afore-mentioned light diffusive plate.

The optical member of the present invention is a light guide plate comprising synthetic resin, wherein at least one end surfaces of the plate is a light incident surface and the surface almost orthogonal with the incident surface is a light emergent surface, and both surfaces and/or end surfaces of the afore-mentioned light guide plate are provided with a moisture proof layer comprising a material having lower vapor permeability than that of the afore-mentioned light guide plate.

The optical member of the present invention is an optical sheet for backlight, wherein both surfaces and/or end surfaces of the optical member are provided with a moisture proof layer comprising a material having lower vapor permeability than that of the afore-mentioned optical member.

The optical member of the present invention is an optical member for a backlight having a functional layer on a synthetic resin substrate, wherein both surfaces and/or end surfaces of the afore-mentioned substrate are provided with a moisture proof layer comprising a material having lower vapor permeability than that of the afore-mentioned substrate.

The backlight of the present invention is a backlight including optical members of the present invention, wherein at least one optical member among light diffusive plate, light guide plate and other optical members that are included in the backlight is the optical member of the present invention.

Specifically, the backlight of the present invention comprises a light source and a light diffusive plate placed over the light source, wherein a light diffusive plate of the present invention is used as the afore-mentioned light diffusive plate.

Further, the backlight of the present invention is a backlight comprising a light guide plate and a light source located at least one end of the afore-mentioned light guide plate, wherein a light guide plate of the present invention is used as the light guide plate.

Further, the backlight of the present invention is a backlight comprising a light source and a light diffusive plate located on the afore-mentioned light source, or a backlight comprising a light guide plate and a light source located on at least one end of the afore-mentioned light guide plate, wherein one or more types of optical sheet or optical members for backlight of the present invention is included in the backlight.

### Effect of the Invention

The optical member of the present invention has a moisture proof layer comprising a material having low vapor permeability on both surfaces and/or end surfaces so that the flat panel-formed optical member, such as light diffusive plate and a light guide plate, can be refrained from formation of deflection and the like. Such optical member, when built in a backlight, can prevent the formation of local wrinkles on the sheet- or film-like optical members to be used in combination with the plate-formed optical member and thereby defective imaging on a liquid crystal display can be prevented. Further, when the optical member is a sheet- or film-like optical member, wrinkles produced due to moisture absorption and release by itself can be prevented, and thereby local defective imaging on a liquid crystal display can be prevented.

Reasons why the formation of deflection and wrinkles is prevented by the present invention will be explained together with the cause of the formation of deflection.

Most of the light diffusive plates and light guide plates are made of synthetic resin in view of the optical characteristics and weight, whereas the synthetic resin in general is highly vapor permeable and likely to absorb moisture. When the optical member consisting of such permeable material is left for long time in a highly humid environment, such optical member absorbs sufficient moisture. And, when a backlight is switched on in the environment where sufficient moisture is absorbed in the optical member, rapid release of moisture begins due to heat of the light source. This release occurs not uniformly within the optical member, but is likely to occur near the light source on a light diffusive plate or a light guide plate. The area where such release occurs is likely to be shrunk and deflected more than the area where absorbed moisture still remains. A deflected light diffusive plate 1 in a direct type backlight is shown in FIG. 12.

Synthetic resin is often used for sheet-like (film-like) optical members, such as prism sheet, light diffusive film, light reflecting film, polarizing film, reflective polarizing film, retardation film and electromagnetic interference (EMI) shielding film and the like (See Patent Reference 1). Accordingly, when such optical members are left under highly humid environment for long time, they are likely to absorb moisture. Absorbed moisture is likely to be released from the area near the end surfaces in the sheet-like optical member 1, and leads to difference in moisture absorption between the internal and the end part. This may cause, for example, the wrinkles shown in FIG. 13.

The wrinkles formed on such sheet-like optical members themselves may constitute a cause for defective imaging on the screen of liquid crystal display. Further, when placed on a deflective light diffusive plate or a light guide plate as above mentioned, wrinkles appear locally on a sheet-like optical member, and cause extremely prominent local defective imaging. Deflection of this optical member is increasingly prominent with the enlarging optical member in response to the enlarging backlight required by the enlarging liquid crystal display.

In the present invention, a moisture proof layer comprising a material with lower vapor permeability than that of the member on both surfaces and/or end surfaces of the optical member prevents the member from absorbing moisture, and prevents quick release of the moisture even though a small amount of moisture is absorbed. This will thus prevent the occurrence of deflection on the optical members, particularly on a light diffusive plate and light guide plate, and thereby prevent local defective imaging on a liquid crystal display.

In the present invention, the effect of the present invention to prevent local defective imaging is obtained by coating a moisture proof layer only on a light diffusive plate for the backlight equipped with a light diffusive plate, only on a light guide plate for the backlight equipped with the light guide plate, or only on a sheet-like optical member for the backlight equipped with a sheet-like optical member. However, when the light diffusive plate or light guide plate is used in combination with a sheet-like optical member, the largest effect can be obtained by providing both of them, the light diffusive plate or light guide plate and the sheet-like optical member, with a moisture proof layer.

Meanwhile, once deflection occurs on a light diffusive plate and light guide plate, it is difficult to make the plates perfectly flat again. Namely, once deflection occurs on the optical members and the like, defective imaging becomes perpetual. Therefore, this invention with an effect to prevent the occurrence of deflection is extremely useful.

There may be a measure to prevent deflection by using synthetic resin with low vapor permeability as a material of the optical member. However, since the resin with low vapor permeability has poorer balance among light permeability, mechanical strength, heat resistance, solvent resistance and price than that of resin (acrylic and polyester resins) constituting optical members used in general, the composition of the present invention is preferable.

### PREFERRED EMBODIMENT OF THE INVENTION

The embodiments of the optical members of the present invention will be explained hereafter.

Firstly, the optical members and the moisture proof layer to which the present invention is applied will be explained.

### 1. Light Diffusive Plate

The light diffusive plate is placed over the light source of the direct type backlight and plays a role to erase the patterns of the light source, which is mainly consisting of synthetic resin. Since such light diffusive plate is used to erase the patterns of light source, its thickness should be as thick as 1 mm-10 mm, unlike a light diffusive film having a thickness of 12 μm-350 μm which is used to improve front luminance and give an appropriate view angle. The area of the light diffusive plate is not particularly limited, but the most prominent effect is obtained for a large light diffusive plate of 900 cm² or larger in which a problem of deflection is likely to occur.

Examples of synthetic resin constituting light diffusive plate include thermoplastic resin, thermosetting resin and ionizing radiation setting resin such as polyester resins, acrylic resins, acrylurethane resins, polyester acrylate resins, polyurethane acrylate resins, epoxy acrylate resins, urethane resins, epoxy resins, polycarbonate resins, cellulose resins, acetal resins, polyethylene resins, polystyrene resins, polyamide resins, polyimide resins, melamine resins, phenol resins and silicone resins. Among them, acrylic resins with excellent optical characteristics are preferably used.

Particles are added in the light diffusive plate to render a light diffusive property. Examples of particles include inorganic particles such as silica, clay, talc, calcium carbonate, calcium sulfate, barium sulfate, aluminum silicate, titanium oxide, synthetic zeolite, alumina and smectite, and organic fine particles made of such resins as styrene resin, urethane resin, benzoguanamine resin, silicone resin and acrylic resin.

### 2. Light Guide Plate

The light guide plate is a virtually plane member that is formed so that at least one end surfaces thereof should serve as a light-incidence surface and a surface virtually perpendicular thereto should serve as a light emergent surface. The light guide plate is, for example, used for an edge-light type backlight. Hereinafter, “on the light emergent surface of the light guide plate and/or on the surface opposite to the light emergent surface” may be sometime referred to as “on the light guide plate”.

The light guide plate consists mainly of synthetic resin, and the surface thereof may have various complicated configurations rather than simple and uniform configuration, or have dot and other patterns made by the diffusion printings. The thickness of the light guide plate is approximately 1 mm-10 mm. The area of the light guide plate is not particularly limited. However, in the present invention, a particularly prominent effect is obtained for a large light diffusive plate of 900 cm² or larger in which a problem of deflection is likely to occur.

As the resin constituting a light guide plate, a resin similar to those exemplified as a resin constituting a light diffusive plate can be used, and particularly acrylic resin with excellent optical characteristics is preferably used. Further, organic particles may be added into a light guide plate as it is required. Organic particles similar to those added into the light diffusive plate can be used.

### 3. Optical Members

Examples of optical members or optical sheet of the present invention include prism sheet, light diffusive film, light reflecting film, polarizing film, reflective polarizing film, retardation film and electromagnetic interference (EMI) shielding film. The light diffusive film is a thin film with a thickness of 12 μm-350 μm to be used for improving front luminance as well as rendering appropriate light diffusiveness, and is different from the afore-mentioned light diffusive plate used for erasing the patterns of light source.

The optical member for backlight 1 may consist of a single material having a required function, as shown in FIG. 1, or may be a functional layer with the said function formed on at lease one surface of the synthetic resin substrate 11 having a film- or plate-like configuration as shown in FIGS. 2 and 3.

Examples of the synthetic resin substrate include substrates consisting of polyethylene terephthalate, polybutylene terephthalate, polycarbonate, acrylic resin and so forth.

The functional layer renders functions to be utilized as an optic member for backlight, such as light diffusing, light reflecting and electromagnetic interference (EMI) shielding functions, and comprises binder resin, pigment and other additives. For example, a layer having a light diffusing function can be formed from a binder resin and particles, while a layer having light reflecting function can be formed from a binder resin and white pigment.

### 4. Moisture Proof Layer

The moisture proof layer is formed as a layer or sealing material (collectively, moisture proof layer) on both surfaces and/or end surfaces of the afore-mentioned light diffusive plate, light guide plate and other optical members (optical sheet), or the substrate composing thereof. The moisture proof layer comprises a material having lower vapor permeability than that of light diffusive plate, light guide plate, or optical sheet or the substrate thereof. Vapor permeability of the moisture proof layer differs depending on the site where the layer is formed and the material thereof, but the upper limit of the permeability is preferably 15 [g/(m²×24 hours)] or less, more preferably 5 [g/(m²×24 hours)] or less and further more preferably 1 [g/(m²×24 hours)] or less. The lower limit of the permeability is approximately 0.01 [g/(m²×24 hours)].

The material with such low vapor permeability may either be inorganic or organic. Examples of inorganic substances include metal compounds such as oxides or halides of silicon, aluminum, titanium, selenium, magnesium, barium, zinc, tin, indium, calcium, tantalum, zirconium, thorium and thallium alone or mixture thereof, and ceramics as glass. Examples of organic substances include synthetic resins such as vinylidene chloride-vinyl chloride copolymer, vinylidene chloride-acrylonitrile copolymer, vinylidene chloride-acrylic copolymer, biaxially oriented polypropylene (OPP), non oriented polypropylene (CPP), cyclic polyolefin, polychloro trifluoro ethylene (PCTFE), tetrafluoroethylen-hexafluoropropylene copolymer (FEP), tetrafluoroethylen-perfluoroalkyl vinylether copolymer (PFA). All of them are the synthetic resins having low vapor permeability.

Among these substances constituting the moisture proof layer, an inorganic substance is preferably used in view of good moisture proof property of the obtained moisture proof layer. In particular, considering the optical characteristics such as transparency, optical transmittance and color, physical properties such as heat resistance and surface hardness, handling-ability, price and so forth, the use of silica is preferable.

Vapor permeability of such low vapor permeable inorganic substance (polyethylene terephthalate having a thickness of 12 μm on which silica having a thickness of 0.04 μm is evaporation-coated, for example) is approximately 1 [g/(m²×24 hours)], and substantially lower than that of 12 μm—thick polyethylene terephthalate alone (40 [g/(m²×24 hours)]). Also, the vapor permeability of organic substance (synthetic resin) having a thickness of 100 μm is approximately 0.2-1.5 [g/(m²×24 hours)], and is considerably lower than that of polyethylene terephthalate having a thickness of 100 μm, which is approximately 6.9 [g/(m²×24 hours)].

### 5. Structure

The optical member of the present invention comprises the member or element constituting the member, wherein both surfaces and/or end surfaces thereof are coated with the afore-mentioned moisture proof layer, and may have various embodiments. Each embodiment will be explained hereafter using drawings, but the present invention is not limited to these embodiments.

FIGS. 4 (a)-(c) are cross sectional views of the light diffusive plate and light guide plate of the present invention. (a) shows the light diffusive plate 1 or light guide plate 1, both surfaces of which are coated with the moisture proof layer 2. (b) shows the light diffusive plate 1 or light guide plate 1, the end surfaces (1a) of which are coated with the moisture proof layer 2. (c) shows the light diffusive plate 1 or light guide plate 1, both and end surfaces of which are coated with the moisture proof layer 2.

FIGS. 5 (a) and (b) are, respectively, the cross sectional view and the plane view showing an embodiment of the optical sheet made of a single layer of the present invention. The illustrated optical sheet for backlight 3 has end surfaces 1a sealed with a material 2 having lower vapor permeability than that of the sheet material.

FIGS. 6 (a)-(c) are the cross sectional views showing embodiments of the present invention applied to the optical sheet 1 (FIGS. 1-3), consisting of a single layer or having a functional layer 12 on one and/or both surfaces of a substrate. The illustrated optical sheets for backlight 3 are provided with the moisture proof layer 2 made of a material having lower vapor permeability than that of the optical sheets or substrate on the both surfaces.

FIGS. 7 (a) and (b) are cross sectional views showing embodiments of the present invention applied to the optical sheets having a functional layer 12 on one or both surfaces of the substrate 11 (FIGS. 2 and 3). The illustrated optical sheets for backlight 3 have the synthetic resin substrate 11, on both surfaces of which a moisture proof layers 2 made of a material having lower vapor permeability than that of the optical sheet or substrate are provided, and the functional layer 12 formed on the moisture proof layer 2.

FIG. 8 shows an optical sheet 1 (FIG. 3) having a functional layer 12 on one surface of the synthetic resin substrate 11, wherein both surfaces of the sheet are provided with a moisture proof layer 2 made of a material having lower vapor permeability than that of the synthetic resin substrate and a functional layer 12 is formed on one of the moisture proof layers 2.

In the optical members having a functional layer on the synthetic resin substrate, deflection is caused mainly by the moisture absorbing property of the synthetic resin, and therefore as shown in FIGS. 7 and 8, deflection can be effectively prevented by forming a moisture proof layer directly on the synthetic resin substrate. However, because an inorganic substance used as a substance with low vapor permeability, for example, protects the surface of the optical member for backlight, unless the characteristics of the optical member are damaged, it is preferable to form a moisture proof layer on the outermost surface of the optical member for backlight. In order to avoid the impairment of the characteristics of the optical member, the moisture proof layer should be made of inorganic substance having a lower refractive index than that of the substrate or the functional layer, and should be formed by adjusting its thickness to a certain level. When the moisture proof layer is on the outermost surface, light transmittance can be improved by controlling the light reflectivity.

FIG. 9 is a cross sectional view of an embodiment of the optical member, wherein not only both surfaces, but also the end surfaces 1a of the optical sheet or synthetic resin substrate is coated with a moisture proof layer 21. FIG. 9 shows the case in which the moisture proof layer is formed on the end surfaces of the optical sheet 3 of FIG. 6 (a). The optical sheets shown in FIGS. 6 (b) and (c), FIG. 7 and FIG. 8 can be composed in the same manner. Further, as the synthetic resin substrate often becomes a crucial cause of the formation of deflection, instead of the end surfaces of the whole optical member, the end surfaces of the synthetic resin substrate may be sealed with a moisture proof layer.

### 6. Method of Forming a Moisture Proof Layer

A moisture proof layer is produced on both and end surfaces of an optical member or substrate, by forming a layer made of the afore-mentioned substance having low vapor permeability using the methods such as vacuum deposition, spattering and ion plating, or by applying the above-mentioned substance with low vapor permeability dissolved in solvent to the surfaces using a known application method, and drying. Alternately, a synthetic resin film provided with the moisture proof layer thereon by the afore-mentioned methods may be laminated on both and end surfaces of the optical member and substrate. Alternately, synthetic resin with low vapor permeability may be made into a film, and the film may be adhered to both and end surfaces of the optical members and substrates by thermo-fusion or with adhesive.

The thickness of the moisture proof layer is not particularly limited, but the thickness of the layer made of inorganic substance is preferably 0.01 μm or more and more preferably 0.02 μm or more. The layer having a thickness of 0.01 μm or more can keep the vapor permeability sufficiently low. Further, the thickness is preferably 0.5 μm or less and more preferably 0.3 μm or less in view of cost performance. When the moisture proof layer is made of organic substance (synthetic resin), the thickness of the layer is preferably 1 μm or more and more preferably 10 μm or more. The layer having a thickness of 1 μm or more can keep the vapor permeability sufficiently low. Further, the thickness is preferably 100 μm or less and more preferably 50 μm or less for avoiding the entire layer becoming excessively thick.

When a moisture proof layer is formed also on the periphery as shown in FIG. 5, a width of the periphery to be sealed with the moisture proof layer is preferably 1 mm or more and more preferably 3 mm or more. When the width of the sealed part is 1 mm or more, vapor permeability can be held sufficiently low. An upper limit of the width of the sealed part is not particularly limited, but is preferably 20 mm or less and more preferably 10 mm or less in view of cost performance and optical characteristics.

The light diffusive plate, light guide plate and optical sheet of the present invention as mentioned above are used mainly as a component of a backlight constituting a liquid crystal display, a light sign board and the like. In particular, a light diffusive plate is used as a component of a direct type backlight, while a light guide plate is used as a component of an edge-light type backlight.

Next, the backlight of the present invention will be explained. The backlight of the present invention comprises at least a light diffusive plate or light guide plate and a light source, and one or more types of optical sheet depending on the purpose, wherein at least one of such light diffusive plate, light guide plate and optical sheet is the afore-mentioned light diffusive plate, light guide plate or optical sheet of the present invention.

As the first embodiment of the backlight of the present invention, the backlight having the light diffusive plate of the present invention will be explained. Generally, the backlight having a light diffusive plate is a direct type backlight, and comprises, as its basic elements, a light source and light diffusive plate located over the light source.

As the light source, a cold-cathode tube is mainly used. Shapes of the light source may be linear, U-shaped and so forth.

As the light diffusive plate, the afore-mentioned light diffusive plate of the present invention is used. Specifically, the light diffusive plate, on both and/or end surfaces a moisture proof layer consisting of synthetic resin with lower vapor permeability than that of synthetic resin constituting the plate, is used.

On the opposite surface of the light diffusive plate to the light source, one or more optical members may be provided depending on the purpose of use. Further, such optical members may be provided on other places inside the direct type backlight, including the side opposite to the light diffusive plate of the light source.

Examples of such optical members include prism sheet, light diffusive film, light reflecting film, polarizing film, reflective polarizing film, retardation film and electromagnetic interference (EMI) shielding film. The optical members of the present invention, specifically, the optical members on both and/or end surfaces of which a moisture proof layer made of substance with low vapor permeability than that of the member is formed, may be used as such optical members, but optical member commonly used may also be used.

Examples of such optical members as prism sheet include “BEF”, “RBEF” and “Wave Film” of Sumitomo 3M Limited and “Diaart” by Mitsubishi Rayon Co., Ltd. Examples of light diffusive film include “Opalus” of Keiwa Inc. and “D114” of Tsujiden Co Ltd. Examples of light reflecting film include “REIRA” of Keiwa Inc. and “ESR” of Sumitomo 3M Limited. Examples of polarizing film include “NPF” of Nitto Denko Corporation and “Sumikaran” of Sumitomo Chemical Co., Ltd. Examples of reflective polarizing film include “DBEF” of Sumitomo 3M. Examples of retardation film include “Elmech” of Kaneka Corporation and “Sumika Light” of Sumitomo Chemical Co., Ltd. Examples of electromagnetic interference shielding film include “Elecrysta” of Nitto Denko Corporation and “Reftel” of Teijin Limited.

FIG. 10 shows an example of typical direct type backlight applying the present invention. In this backlight 9, as shown in the figure, multiple light sources 7 are placed on the reflecting film 6 housed in the chassis 8, and on top of it a reflecting film 4 and prism sheet 5 are placed via the light diffusive plate 31 of the present invention.

Since the backlight of this embodiment uses a light diffusive plate, on both and/or end surfaces of which a moisture proof layer composed of a material with low vapor permeability is formed, no deflection occurs on the light diffusive plate and also the deflection on the optical members placed on the light diffusive plate are protected. Accordingly, local defective imaging on the display can be protected. Particularly, the most prominent effect is obtained in the backlight having a large light emergent surface of 900 cm² or more in which a problem of deflection is likely to occur. Since such large-area backlight is widely used as the direct type backlight, the present invention is particularly suitable for the direct type backlight.

Next, the second embodiment of the present embodiment comprising the backlight having a light guide plate of the present invention is explained. The backlight having a light guide plate is, in general, an edge-light type backlight, and comprises, as its basic elements, a light guide plate and light source arranged at least one end of the light guide plate.

As the light source, mainly a cold-cathode tube is used. Shapes of the light source may be linear, L-shaped and so forth.

On the light emergent surface and/or the surface opposite to the light emergent surface of the light guide plate of the edge-light type backlight, one or more optical members may be located, in accordance with the purpose of use. Examples of such optical members include, as exemplified for the direct type backlight, prism sheet, light diffusive film, light reflecting film, polarizing film, reflective polarizing film, retardation film, electromagnetic interference (EMI) shielding film, and the like. Further, such optical members may be placed in other places inside the edge-light type backlight, such as at the area surrounding the light source of the edge-light type backlight. In this embodiment, the optical member of the present invention having a moisture proof layer on both and/or end surfaces of the member or substrate may be used for all or a part of such optical members.

FIG. 11 shows an example of typical edge-light type backlight applying this invention. This backlight 9 comprises the light sources 7 located on both ends of the aforementioned light guide plate 32 of this invention, wherein the light diffusive film 4 and the prism sheet 5 are placed on top of the light guide plate 32. In order for the light from the light sources 7 effectively enter the light guide plate 32, the light sources 7 are covered with the reflecting film 6 excepting the part facing the light guide plate 32. Under the light guide plate 32, a reflecting film 6 housed in a chassis 8 is equipped. This returns the light emitted to the side opposite to the light emitting side of the light guide plate 32 back into the light guide plate 32, thereby increasing the emitting light from the light emergent surface of the light guide plate 32.

As the backlight of this embodiment uses a light guide plate having a moisture proof layer made of a material with low vapor permeability on both and/or end surfaces, the same effect of the backlight of the first embodiment can be obtained.

As described in the above explanation of the embodiments of the present invention, either of the light diffusive plate, light guide plate or other optical member in the backlight of the present invention needs to have the characteristics of the optical member of the present invention. The present invention contains, for example, the direct type backlight comprising a conventional light diffusive plate, which is produced by adding inorganic or organic fine particles to render light diffusiveness on the synthetic resin, and the optical member such prism sheet, light diffusive film, light reflecting film, polarizing film, reflective polarizing film, retardation film and electromagnetic interference shielding film, at least one of which has a moisture proof layer on both and/or end surfaces of the member or substrate, and the edge-light type backlight comprising a conventional light guide plate made of synthetic resin, combined with other optical members, at least one of which has a moisture proof layer on both and/or end surfaces of the member or substrate.

### EXAMPLES

The present invention will be explained with examples hereinafter. In the following examples, “part” and “%” are used on a weight basis unless otherwise indicated.

### Example 1

A direct type backlight (the area of light emergent surface is 2090 cm²) was removed from a commercially available 26-inch liquid crystal television having a direct backlight as a backlight. The direct type backlight comprised a light diffusive plate, light diffusive film, prism sheet and polarizing film over a light source.

Then, a light diffusive plate (2,090 cm²) made of acrylic resin was removed from the direct type backlight, and a following coating solution for a moisture proof layer using vinylidene chloride resin as the material with lower vapor permeability than that of the light diffusive plate was applied on both surfaces of the light diffusive plate and dried, to form a moisture proof layer having vapor permeability of about 7 [g/(m²×24 hours)]. Thus the light diffusive plate of the present invention was obtained. Then by placing back the light diffusive plate back into the backlight, the backlight of the present invention was obtained.

<A coating solution for a moisture proof layer>

| | |
|---|---|
| Vinylidene chloride-acrylonitrile copolymer | 50 parts |
| (Krehalon SOA: Kureha Corporation) | |
| Methylethyl keton | 25 parts |
| Butyl acetate | 25 parts |

### Example 2

An edge-light type backlight (the area of light emergent surface is 993 cm²) was removed from a commercially available 18-inch liquid crystal display of a desk top personal computer having an edge-light type backlight as a backlight. The edge-light type backlight had a light source on both ends of the light guide plate, a light diffusive film, prism sheet and polarizing film on the light emergent surface of the light guide plate and a reflecting film on the surface opposite to the light emergent surface of the light guide plate.

Then, the light guide plate (993 cm²) made of acrylic resin was removed from the edge-light type backlight, and the same coating solution as in Example 1 for a moisture proof layer using vinylidene chloride resin as a substance with low vapor permeability than that of the light guide plate, was applied on both surfaces of the light guide plate and dried to form a moisture proof layer having vapor permeability of approximately 7 [g/(m²×24 hours)]. Thus the light guide plate of the present invention was obtained. Then, by placing the light guide plate back into the backlight, the backlight of the present invention was obtained.

### [Evaluation of Deflection]

After the backlights obtained in Examples 1 and 2 were left for 24 hours at the temperature of 40° C. and the relative temperature of 90%, they were placed back into the commercially available 26-inch liquid crystal television and the commercially available liquid crystal display for 18-inch desk top PC, respectively. Then, the liquid crystal television and the liquid crystal display were switched on, and how the imaging conditions would change was observed. Then, the backlights which had been built in the liquid crystal television and the liquid crystal display were removed from them and observed. No defective imaging was observed several hours after the display was switched on in neither Examples 1 nor Example 2. No deflection was observed on the light diffusive plate or light guide plate, and no local wrinkle was observed on the light diffusive film, prism sheet or polarizing film.

### Comparative Examples 1 and 2

The backlight of Comparative Example 1 was obtained in the same manner as in Example 1 except that no moisture proof layer was formed on the light diffusive plate. Further, the backlight of Comparative Example 2 was obtained in the same manner as in Example 2 except that no moisture proof layer was formed on the light guide plate. The deflection on the obtained backlights of Comparative Examples 1 and 2 was evaluated in the same manner as Examples 1 and 2. As the result, a phenomenon that the areas with different imaging from the surrounding area occurred locally on the liquid crystal display three hours after the liquid crystal television and the liquid crystal display were switched on was observed. The size of this localized defective imaging portion was gradually decreased in time course, but did not disappear even after several days. Then, the backlights which had been built in were removed from the liquid crystal television and liquid crystal display and observed. The former backlight showed deflection on the light diffusive plate and local wrinkles on the light diffusive film, prism sheet and polarizing film. The latter backlight showed deflection on the light guide plate, and local wrinkles on the light diffusive film, prism sheet, polarizing film and reflecting film.

### Example 3

A coating solution for a light diffusive layer of the following formulation was applied onto one surface of a synthetic resin substrate (polyethylene terephthalate having a thickness of 100 μm) having vapor permeability of approximately 6.9 [g/(m²×24 hours)] and dried to form a light diffusive layer having the post-drying thickness of 12 μm. Thus the light diffusive film was obtained.

<A coating solution for a light diffusive layer>

| | |
|---|---|
| Acrylpolyol | 10 parts |
| (Acrydick A-807: Dainippon Ink and Chemicals' Inc.) | |
| Polyisocyanate | 2 parts |
| (Takenate D110N: Mitsui Takeda Chemicals Inc.) | |
| Acrylic resin particles | 10 parts |
| (Techpolymer MBX-8: Sekisui Plastics Co., Ltd.) | |
| Methylethyl keton | 18 parts |
| Butyl acetate | 18 parts |

Then, the end surfaces and the periphery part of the light diffusive film was sealed with a silica deposition film (Techbarrier V: Mitsubishi Plastics Inc., vapor permeability of approximately: 0.7 [g/(m²×24 hours)]) having sufficiently lower vapor permeability than that of the light diffusive film, through adhesive. The width of the sealed periphery was 10 mm. Thus the optical member for the backlight (light diffusive film) of the present invention was obtained.

Then, the light diffusive plate was placed over a light source, and on the light diffusive plate the optical member (light diffusive member) for the backlight of the present invention obtained in Example 3 was placed. Thus the direct type backlight (26-inch size) of the present invention was obtained.

### Example 4

The end surfaces and the periphery part of a synthetic resin substrate (polyethylene terephthalate, thickness of 100 μm) having vapor permeability of approximately 6.9 [g/(m²×24 hours)] was sealed with a silica deposition film (Techbarrier V: Mitsubishi Plastics Inc., vapor permeability of approximately 0.7 [g/(m²×24 hours)] having low vapor permeability through adhesive. The width of the sealed periphery was 10 mm.

Then, by forming a light diffusive layer on the sealed synthetic resin substrate in the same manner as in Example 3, the optical member for backlight (light diffusive film) of the present invention was obtained.

Then, light sources were placed on both ends of the light guide plate, and then the optical member for backlight (light diffusive film) of the present invention obtained in Example 4 was placed on the light emergent surface of the light guide plate. Thus, the edge-light type backlight of the present invention (18-inch size) was obtained.

### Example 5

A moisture proof layer having vapor permeability of about 0.5 [g/(m²×24 hours)] was formed on both surfaces of a light diffusive film produced in the same manner as in Example 3 by the spattering method using silica as the material with low vapor permeability, and thus the optical member for backlight (light diffusive film) of Example 5 was obtained.

Then, the light diffusive plate was placed over a light source, and then the optical member for backlight (light diffusive film) of the present invention obtained in Example 5 was placed on the light diffusive plate. Thus, the direct type backlight (26-inch size) of the present invention was obtained.

### Example 6

After forming a moisture proof layer having vapor permeability of about 0.5 [g/(m²×24 hours)] on both surfaces of a synthetic resin substrate (polyethylene terephthalate of 100 μm) having vapor permeability of about 6.9 [g/(m²×24 hours)] by the spattering method using silica as the material with low vapor permeability, a light diffusive layer was formed on either moisture proof layer as in Example 5. Thus the optical member for backlight (light diffusive film) of Example 6 was obtained.

Then, light sources were placed on both ends of the light guide plate, and then the optical member for backlight (light diffusive film) of the present invention obtained in Example 6 was placed on the light emergent surface of the light guide plate. Thus, the edge-light type backlight of the present invention (18-inch size) was obtained.

### [Evaluation of Deflection]

Evaluation of deflection conducted as in the same manner as Examples 1 and 2 revealed that no defective imaging was observed in neither of Examples 3 to 6 for several hours after the switch was on. On neither of the optical member for backlight (light diffusive film) which had been built in a liquid crystal television and liquid crystal display and then removed from it, local wrinkle was observed.

### Comparative Examples 3 and 4

On the other hand, a light diffusive film and a backlight of Comparative Examples of 3 and 4 were obtained in the same manner as in Examples 3 and 4, except that no moisture proof layer was formed on the optical member for backlight of Examples 3 and 4. In the evaluation of deflection on thus obtained backlight of Comparative Examples of 3 and 4 in the same manner as in Examples 1 and 2, a phenomenon that the areas with different imaging from the surrounding area occurred locally on the liquid crystal display three hours after the liquid crystal television and the liquid crystal display were switched on was observed. The size of this localized defective imaging was gradually decreased in time course, but did not disappear even after several days. Further, localized wrinkles were observed on the optical members for backlight (light diffusive film) which had been built in the liquid crystal television and the liquid crystal display and removed from them.

### BRIEF EXPLANATION OF DRAWINGS

FIG. 1 A cross sectional view showing an example of the conventional optical member for backlight

FIG. 2 A cross sectional view showing another example f the conventional optical member for backlight

FIG. 3 A cross sectional view showing another example of the conventional optical member for backlight

FIG. 4 A cross sectional view showing an embodiment of the light diffusive plate of the present invention or the light guide plate of the present invention

FIG. 5 An embodiment of the optical member for backlight of the present invention, where (a) is a cross sectional view and (b) is a plan view.

FIG. 6 A cross sectional view showing multiple embodiments of the optical members for backlight of the present invention.

FIG. 7 A cross sectional view showing multiple embodiments of the optical member for backlight of the present invention.

FIG. 8 A cross sectional view showing another embodiment of the optical member for backlight of the present invention

FIG. 9 A cross sectional view showing another embodiment of the optical member for backlight of the present invention.

FIG. 10 A cross sectional view showing an embodiment of the backlight of the present invention.

FIG. 11 A cross sectional view showing another embodiment of the backlight of the present invention.

FIG. 12 A figure explaining the status of deflection on the light diffusive plate or light guide plate.

FIG. 13 A figure explaining the status of deflection on the optical sheet.

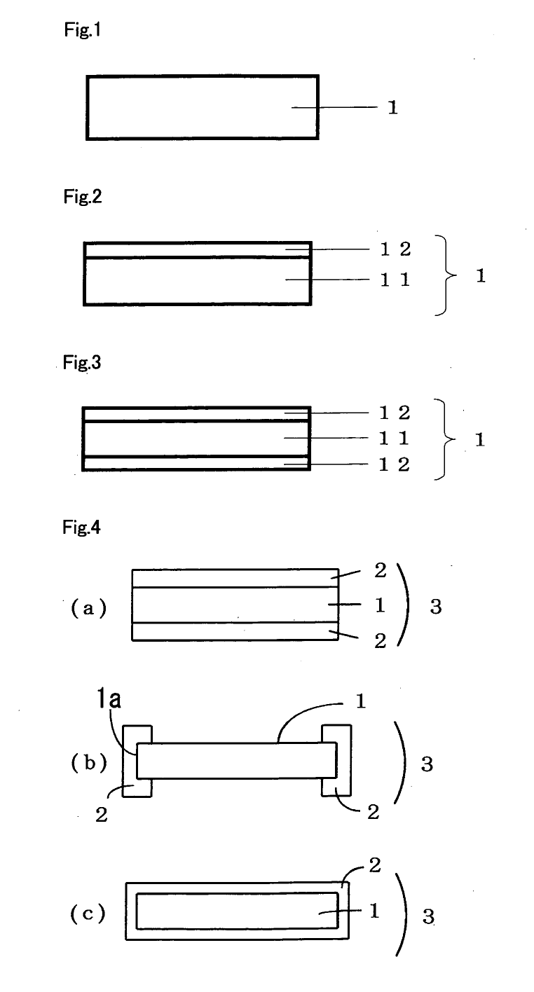

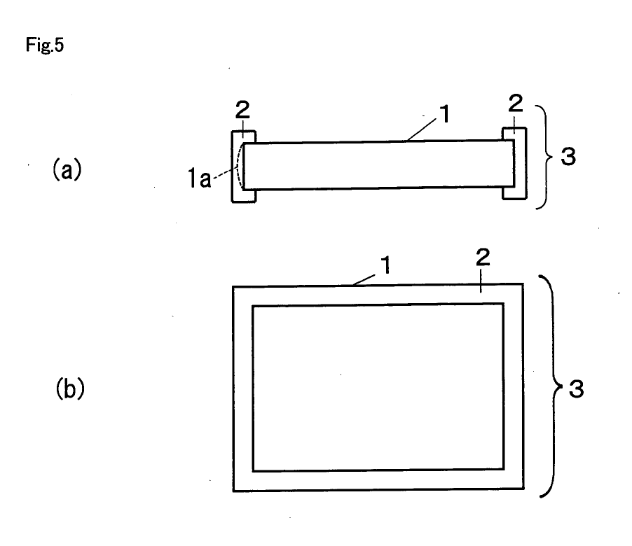

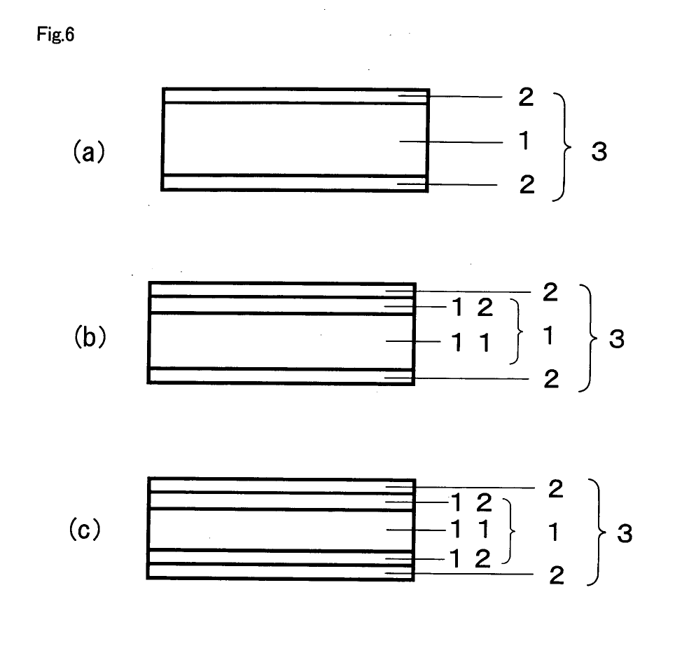

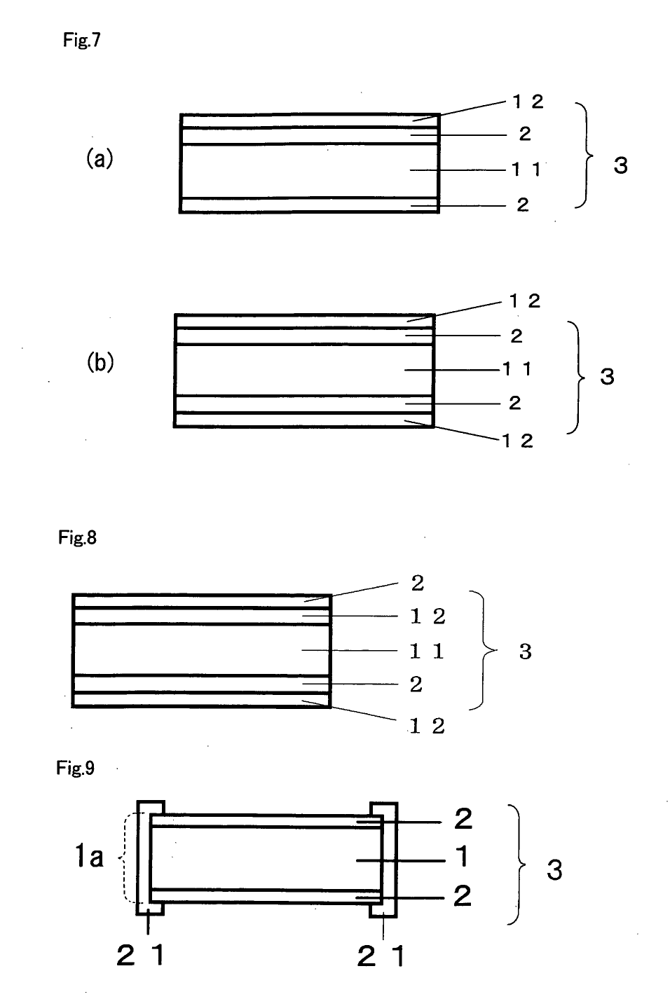

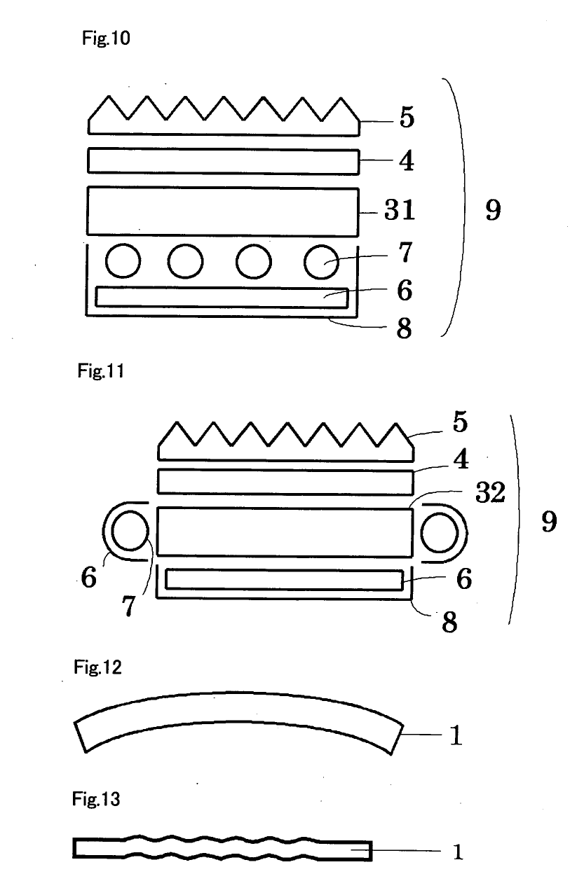

1. A planar optical member comprising a single or multiple layers, wherein both surfaces and/or end surfaces of at least one of the layers constituting the optical member is coated with a moisture proof layer made of a material having lower vapor permeability than that of said one of the layers.

2. The optical member according to claim 1, wherein the optical member is a light diffusive plate made of synthetic resin, and both surfaces and/or end surfaces of the light diffusive plate are provided with a moisture proof layer made of a material having lower vapor permeability than that of the light diffusive plate.

3. The optical member according to claim 1, wherein the optical member is a light guide plate made of synthetic resin having at least one end as a light incident surface, and the surface almost orthogonal with the light incident surface as a light emergent surface, and both surfaces and/or end surfaces of the light guide plate are provided with a moisture proof layer made of a material having lower vapor permeability than that of the light guide plate.

4. The optical member according to claim 1, wherein the optical member is an optical sheet for backlight.

5. The optical member according to claim 1, wherein the optical member is an optical member for backlight having a functional layer on a synthetic resin substrate, and both surfaces and/or end surfaces of the substrate are provided with a moisture proof layer made of a material having lower vapor permeability than that of the substrate.

6. The optical member according to claim 4, wherein the optical member is selected from a prism sheet, light diffusive film, light reflecting film, polarizing film, reflective polarizing film, retardation film and electromagnetic interference (EMI) shielding film.

7. The optical member according to claim 4, wherein the moisture proof layer made of the low vapor permeable material is formed on the outermost surface of the optical member for backlight.

8. The optical member according to claim 1, wherein the vapor permeability of the moisture proof layer made of the low vapor permeable material is not more than 15 [g/(m²×24 hours)].

9. The optical member according to claim 1, wherein the low vapor permeable material comprises one or more inorganic metal compounds selected from oxides or halides of silicon, aluminum, titanium, selenium, magnesium, barium, zinc, tin, indium, calcium, tantalum, zirconium, thorium and thallium.

10. The optical member according to claim 9, wherein the inorganic metal compound is silica.

11. The optical member according to claim 1, wherein the low vapor permeable material comprises one or more types of synthetic resin selected from vinylidene chloride-vinyl chloride copolymer, vinylidene chloride-acrylonitrile copolymer, vinylidene chloride-acrylic copolymer, biaxially oriented polypropylene (OPP), non oriented polypropylene (CPP), cyclic polyolefin, polychloro trifluoro ethylene (PCTFE), tetrafluoroethylene-hexafluoropropylene copolymer (FEP) and tetrafluoroethylene-perfluoroalkyl vinylether copolymer (PFA).

12. The optical member according to claim 11, wherein the synthetic resin is vinylidene chloride-acrylonitrile copolymer.

13. A backlight comprising a light source and a light diffusive plate placed over the light source, wherein the backlight is the light diffusive plate according to claim 2.

14. The backlight according to claim 13, wherein the light diffusive plate is provided with one or more types of optical members on the surface opposite to the light source.

15. The backlight according to claim 14, wherein the optical member comprises a single or multiple layers, wherein both surfaces and/or end surfaces of at least one of the layers constituting the optical member is coated with a moisture proof layer made of a material having lower vapor permeability than that of said one of the layers.

16. A backlight comprising a light guide plate and a light source placed on at least one end of the light guide plate, wherein the light guide plate according to claim 3 is used as the light guide plate.

17. The backlight according to claim 16, wherein one or more types of optical member is placed on the light emergent surface and/or the surface opposite to the light emergent surface of the light guide plate.

18. The backlight according to claim 17, wherein the optical member comprises a single or multiple layers, wherein both surfaces and/or end surfaces of at least one of the layers constituting the optical member is coated with a moisture proof layer made of a material having lower vapor permeability than that of said one of the layers.

19. A backlight comprising a light source and a light diffusive plate placed over the light source, wherein one or more optical members for backlight according to claim 4 are provided inside the backlight.

20. A backlight comprising a light guide plate and light sources placed on at least one end of the light guide plate, wherein one or more optical members for backlight according to claim 4 are provided inside the backlight.
